(19) United States
(12) Patent Application Publication
(10) Pub. No.: US 2008/0026358 A1
(43) Pub. Date: Jan. 31, 2008

(54) Systemic education module

(76) Inventor: Hsiang-Chia Su, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/487,382

(22) Filed: Jul. 17, 2006

(51) Int. Cl. G09B 3/00

(52) U.S. Cl. 434/322

(57) ABSTRACT

An education module increases the faculties of students, such as the thoroughgoing digestion of information and the enlivening of the imagination, based on a tree structure concept that increases the scope of curriculums, and a hierarchical concept that increases the profundity of curriculums. Moreover, after finishing the basic curriculums, students should understand what they have been taught. The method determines whether or not to teach students the profounder curriculums based on the volition of students for discovering what students find interesting.

### BACKGROUND OF THE INVENTION

1. Field of the Invention

The present invention relates to an education module, and more particularly to a systemic education module.

2. Description of the Prior Art

In the current era, many students undergo spoon-fed lessons that are born of uncreative and unimaginative education principles and methods. As a result of such a boring learning environment, many students feel uninterested in learning and decide to drop out rather than endure the ennui and competitive nature of high social academics. Some ameliorated education methods are developing, such as digital education and the Montessori method of teaching. However, these methods have not yet been properly refined to meet the expectations and standards of both students and parents.

Because the above ameliorated education methods divided learning into several independent courses, such as English, Mathematics and History, students cannot learn systematically and fail to completely digest information thoroughly and may even become bored with learning. Moreover, in order to increase the competitiveness of students, many educators and parents of students force students to learn through traditional rote methods. Despite individual students' requirements, the above teaching methods merely provide identical modules embodied in courses, and do not follow a course of enquiry reflecting what an individual student enjoys and finds interesting.

Therefore, students' talents are often ignored or even undiscovered, and students always feel learning is boring, becoming automatons in their later life, doomed to a life of normality.

### SUMMARY OF THE INVENTION

It is the object of the present invention to increase the scope of curriculums based on the tree structure in concept formation and to increase the profundity of curriculums based on the hierarchical concept.

It is another object of the present invention that each knowledge territory includes a plurality of subjects, and each of the subjects includes a plurality of units, and each unit includes a plurality of courses. Therefore, the present invention increases the faculties of students, such as the thoroughgoing digestion of information and an enlivening of the imagination.

It is another object of the present invention to execute more difficult curriculums based on the volition of each student after they have completed the basic curriculums, for further discovering where the students' interest lie.

It is another object of the present invention to teach not only via digital education methods according to the hardware being used (such as computers) and the network, but also through real life education.

In order to achieve the above objects, the present invention provides a systemic education module. One by one, the systemic education module selects one of a plurality of knowledge territories, selects one of a plurality of subjects in the selected knowledge territory, selects one of a plurality of units in the selected subject and selects one of a plurality of courses in the selected unit for further teaching each of the courses. When all of the knowledge territories are finished, the present invention executes an adaptive estimate to get an estimate result.

Furthermore, the image sections are the product of horizontal M pixel units and vertical N pixel line units. The video signal control unit predeterminedly tunes the color temperatures of the image sections to be different and belong to different color temperature units.

### BRIEF DESCRIPTION OF THE DRAWINGS

The above and further advantages of this invention may be better understood by referring to the following description, taken in conjunction with the accompanying drawings, in which:

FIG. 1 is a flow chart of the systemic education module of the present invention; and

FIG. 2 is a flow chart of hierarchical curriculums of the present invention.

The drawings will be described further in connection with the following detailed description of the present invention.

### DETAILED DESCRIPTION OF THE PREFERRED EMBODIMENTS

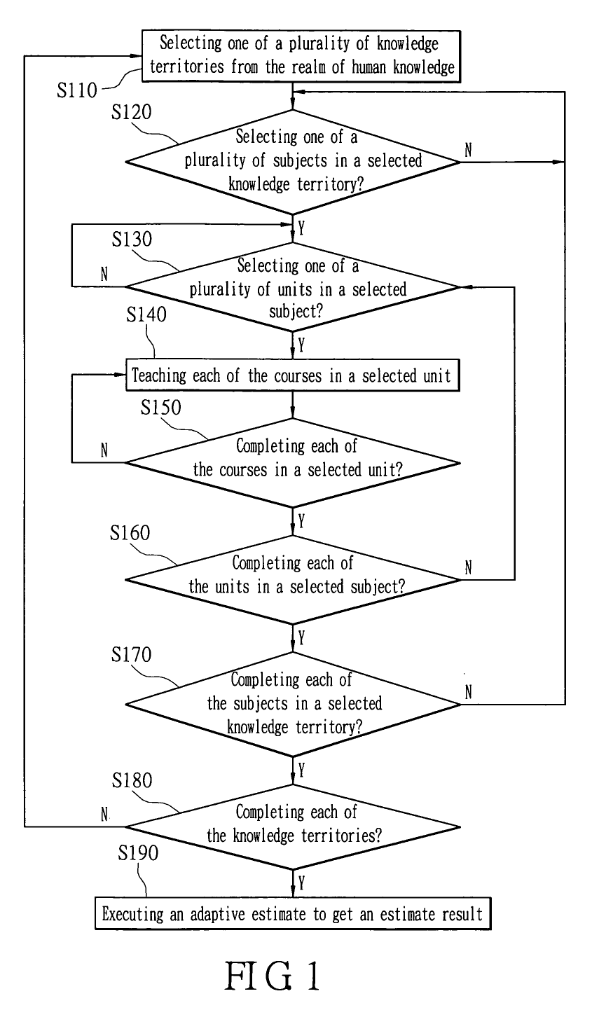

In the realms of human knowledge there are a plurality of knowledge territories, such as biocenology, astrophysics, architectural art, history, science and technology, ecology, archeology. Referring to FIG. 1, a flow chart that illustrates systemic education modules of the present invention is shown.

First, one of the knowledge territories is selected (S110) and it is determined whether the selected knowledge territory suits a student based on the systemic education module. The selected knowledge territory includes a plurality of subjects. For example, biocenology includes an entomology subject, a botany subject, and a zoology subject; astrophysics includes a geophysics subject, an astronomy subject, and a space science subject; architectural art includes a traditional China architecture subject, a Renaissance architecture subject, and a Baroque architecture subject; science and technology includes a material science subject, a application technology subject, and an ecosystem subject; history includes a classical biological history subject, an art history subject, and a traffic history subject; ecology includes an environmental protection subject, an environmental engineering subject, and a phenology subject; archeology includes an anthropogeny subject, a relic subject, and a humanism subject.

Next, one of a plurality of subjects in a selected knowledge territory are selected and it is determine whether or not to teach the student the selected subject (S120. If the selected subject is correct for the student, the present invention teaches the selected subject to the student. If the selected subject is incorrect, the present invention selects another subject from the plurality of subjects in the selected knowledge territory. Moreover, there are a plurality of units in each of the subjects. For example, entomology includes Allomyrina dichotomas, flower beetles, stag beetles, butterflies, and fireflies.

Therefore, one of a plurality of units in selected subject are selected, and it is determined whether or not to teach the student the selected unit (S130). If the selected unit is correct, the present invention teaches the selected unit to the student. If the selected unit is incorrect, the present invention selects another unit in the selected subject. Moreover, there are a plurality of courses in each unit, such as Chinese literature, foreign literature, history, geography, humanities, mathematics, science, biology, art, musicology, body language, emotional intelligence. One by one, the present invention executes teaching the student each of the courses in the selected unit (S140).

Next, the present invention determines whether or not all of the courses have been finished (S150). If all of the courses have not been finished, the present invention selects the next course in the selected unit for further teaching the last selected course to the student. If all of the courses have been finished, the present invention determines whether all of the units have been finished (S160).

If all of the units have not been finished, the present invention selects the next unit in the selected subject for further teaching of the last selected unit to the student. If all of the units have been finished, the present invention determines whether all of the units in the selected subject have been finished (S170).

If all of the subjects have not been finished, the present invention selects the next subject in the selected knowledge territory for further teaching of the last selected subject to the student. If all of the subjects have been finished, the present invention determines whether all of the knowledge territories in the human category have been finished (S180).

If all of the knowledge territories have not been finished, the present invention selects the next knowledge territory in the human category for further teaching of the last selected knowledge territory to the student. If all of the knowledge territories have been finished, the present invention performs an adaptive estimate of the student to get an estimate result to establish a level of the student (S190).

Furthermore, there are N steps of the curriculum in each of the courses. N is a constant, such as 1, 2 or 3. The present invention defines each of the courses by different curriculum profundities, and periods by the contents of each of the courses. Therefore, the first step of the curriculum is a portion of the basic curriculums the student should understand. The larger the value of N, the larger the scope of the selected course is.

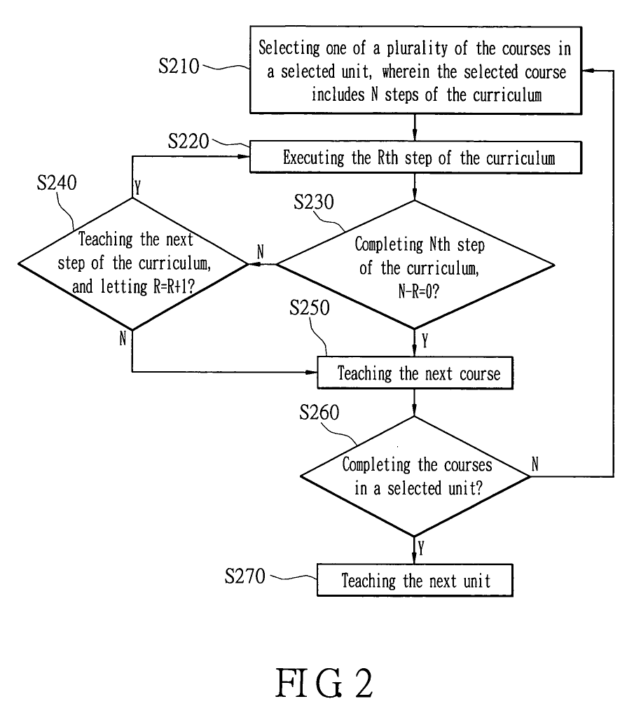

Reference to FIG. 2, a flow chart of hierarchical curriculums of the present invention is shown. The present invention teaches the selected course that includes N steps of the curriculum (S210). First, the present invention teaches the Rth step of the curriculum (S220). R is a constant, such as 1, 2, or N, and illustrates the curriculum profundity of the selected course. The value of R is larger, and the curriculum profundity of the selected course is more difficult. However, the value of R begins from between 1 to N.

Next, the present invention determines whether or not all of the N steps of the curriculum in the selected course have been finished (S230). Here, the present invention determines whether or not R is N, and whether R subtracted from N is zero. If all of the N steps of the curriculum have been finished, the present invention selects the next course from a plurality of courses in a selected unit and teaches the last selected course (S250). If all of the N steps of the curriculum have not been finished, the present invention determines whether to execute the next step of the curriculum (R=R+1) in the N steps of the curriculum based on the volition of the student (S240).

Furthermore, if the student is interested in the Rth step of the curriculum and agrees to study the next step of the curriculum in the selected course, the present invention teaches the next step of the curriculum (S220). In this case, the next step of the curriculum means the (R=R+1) step of the curriculum.

If the student is not interested in the Rth step of the curriculum and doesn't want to study the next step of the curriculum in the selected course, the present invention finishes the basic curriculums in the selected course that the student should understand, and teaches the next course in the selected unit (S250).

The present invention next determines whether or not all of the courses in the selected unit have been finished (S260). If all of the courses have not been finished, the present invention continuously selects another course for further teaching of the last selected course (S210). If all of the courses have been finished, the present invention teaches the next unit in the selected subject (S270).

For example, supposing the selected course includes a three step curriculum (N=3). First, the present invention teaches the first step curriculum (R=1) to the student. After finishing the first step curriculum, the present invention determines whether or not all of the three step curriculum have been finished, i.e. if R=3, or R subtracted from 3 is zero. If R subtracted from 3 is zero, the result means all three steps of the curriculum have been finished. If R subtracted from 3 is not zero, the result means not all of three steps of the curriculum have been finished.

Next, if all three steps of the curriculum are finished, the present invention teaches the next course in the selected unit to the student. If all three steps of the curriculum are not finished, the present invention determines whether to teach the second step of the curriculum based on the volition of the student. That is, if the student found the first step curriculum interesting and agrees to study the second step curriculum, the present invention teaches the second step of the curriculum to the student. On the other hand, if the student did not find the first step of the curriculum interesting and doesn't wish to study the second step of the curriculum, the present invention teaches the next course.

Furthermore, the present invention teaches not only via digital education methods according to the network and the hardware (such as computers) being used, but also through real life education so as to teach using the systemic education module to students around the world.

The advantage of the present invention is that it increases the scope of curriculums based on the tree structure in concept formation and increases the profundity of curriculums based on the hierarchical concept.

Another advantage of the present invention is that each of the knowledge territories includes a plurality of subjects, and each of the subjects includes a plurality of units, and each unit includes a plurality of courses. Therefore, the present invention increases the faculties of students, such as the thoroughgoing digestion of information and the enlivening of the imagination.

Another advantage of the present invention is that the present invention executes more difficult curriculums based on the volition of each student after finishing the basic curriculums. Therefore, the present invention discovers what students find interesting.

Another advantage of the present invention is that the present invention can teach not only via digital education methods according to the hardware (such as computers) and the network being used but also through real life education.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A systemic education module, comprising:
selecting one of a plurality of knowledge territories;
selecting one of a plurality of subjects in the selected knowledge territories;
selecting one of a plurality of units in the selected subject;
selecting one of a plurality of courses in the selected unit for further teaching of the selected course; and
executing an adaptive estimate to get an estimate result to determine whether all the knowledge territories are selected.

2. The systemic education module according to claim 1, wherein the systemic education module increases the range of a curriculum based on a tree structure of concept formation.

3. The systemic education module according to claim 1, wherein the systemic education module increases the profundity of a curriculum based on a hierarchical concept.

4. The systemic education module according to claim 1, wherein the knowledge territories comprise biocenology, astrophysics, architectural art, history, science and technology, ecology and archeology.

5. The systemic education module according to claim 4, wherein the selected subject in astrophysics is a geophysics subject, a botany subject, or a zoology subject.

6. The systemic education module according to claim 4, wherein the selected subject in biocenology is an entomology subject, an astronomy subject, or a space science subject.

7. The systemic education module according to claim 4, wherein the selected subject in architectural art is a traditional China architecture subject, a Renaissance architecture subject, or a Baroque architecture subject.

8. The systemic education module according to claim 4, wherein the selected subject in science and technology is a material science subject, an application technology subject, or an ecosystem subject.

9. The systemic education module according to claim 4, wherein the selected subject in history is a classical biological history subject, an art history subject, or a traffic history subject.

10. The systemic education module according to claim 4, wherein the selected subject in ecology is an environmental protection subject, an environmental engineering subject, or a phenology subject.

11. The systemic education module according to claim 4, wherein the selected subject in archeology is an anthropogeny subject, a relic subject, or a humanism subject.

12. The systemic education module according to claim 1, wherein the selected course is Chinese literature, foreign literature, history, geography, humanities, mathematics, science, biology, art, musicology, body language, or emotional intelligence.

13. The systemic education module according to claim 1, wherein each of the courses in the selected unit comprises at least a first step of the curriculum.

14. The systemic education module according to claim 13, wherein the first step of the curriculum is a basic curriculum.

15. The systemic education module according to claim 13, wherein teaching of the selected course comprises:
teaching the first step of the curriculum in the selected course;
determining whether to teach a next step of the curriculum in the selected course according to the volition of a student;
determining whether to teach the next course according to the volition of the student and finishing each of the curriculums in the selected course; and
determining whether to teach the next unit according to whether or not each of the courses in the selected unit have been finished or not.

16. The systemic education module according to claim 15, wherein the next course is taught if the student doesn't wish to study the next step of the curriculum, and teaching the next step of the curriculum if the student agrees to study the next step of the curriculum.

17. The systemic education module according to claim 1, wherein at least one hardware and a network that embodies the systemic education module is used.
